(19) United States
(12) Patent Application Publication
(10) Pub. No.: US 2006/0158567 A1
(43) Pub. Date: Jul. 20, 2006

(54) Luminance and color separation

(76) Inventors: Claus Nico Cordes, Eindhoven (NL); Gerard De Haan, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/560,719

(22) PCT Filed: Jun. 17, 2004
(86) PCT No.: PCT/IB04/50925

§ 371 Date: Dec. 15, 2005

(30) Foreign Application Priority Data
Jun. 20, 2003 (EP) 03101832.8

(51) Int. Cl. H04N 9/77

(52) U.S. Cl. 348/663

(57) ABSTRACT

A luminance and color separation filter unit (300) for extracting a luminance signal (Y) and two color signals (U, V) from a composite color television signal (CVBS). The filter unit (300) comprises: acquisition means (302) to acquire a first sample of the composite color television signal, corresponding to a first pixel and other samples, corresponding to other pixels in a neighborhood of the first pixel; correlation estimation means (304) to estimate a first set of correlation values representing correlations between the first sample and the respective other samples; penalty estimation means (306) to estimate a second set of penalty values representing relations between the first sample and the respective other samples; computing means (308) to compute a third set of combined values by means of combining respective elements of the first set and the second set; selection means (310) to select a particular sample of the composite color television signal on basis of the corresponding combined value; and decoding means (312) to determine a final luminance value and two color values corresponding to the first pixel, on basis of the first sample and the particular sample.

The invention relates to a luminance and color separation filter unit for extracting a luminance signal and two color signals from a composite color television signal, comprising a chrominance signal being modulated on a sub-carrier which is located in the high-frequency part of the frequency spectrum of the luminance signal.

The invention further relates to an image processing apparatus comprising:

receiving means for receiving a composite color television signal, comprising a chrominance signal being modulated on a sub-carrier which is located in the high-frequency part of the frequency spectrum of a luminance signal; and

a luminance and color separation filter unit for extracting the luminance signal and two color signals from the composite color television signal.

The invention further relates to a method of extracting a luminance signal and two color signals from a composite color television signal, comprising a chrominance signal being modulated on a sub-carrier which is located in the high-frequency part of the frequency spectrum of the luminance signal.

The invention further relates to a computer program product to be loaded by a computer arrangement, comprising instructions to extract a luminance signal and two color signals from a composite color television signal, comprising a chrominance signal being modulated on a sub-carrier which is located in the high-frequency part of the frequency spectrum of the luminance signal, the computer arrangement comprising processing means and a memory.

With HDTV sets becoming readily available in many markets, digital television is rapidly gaining popularity. However, analog television is expected to remain the most important television standard for the foreseeable future. With the advent of increasingly larger televisions that exhibit significantly higher resolutions, a continued quality improvement of the decoded analog television signal is desirable.

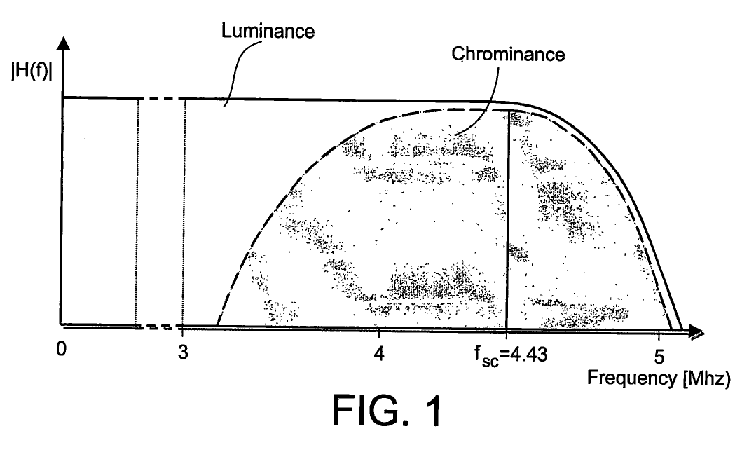

Many artifacts that continue to exist in analog television are caused by the imperfect separation of luminance and chrominance in composite color video signals. This separation is required due to the fact that the chrominance component (C) is transmitted by modulating it onto a sub-carrier in the high-frequency part of the luminance, i.e. gray-value (Y) spectrum, as illustrated in FIG. 1. As both components share the same frequency space, their separation at the receiver side can only be imperfect and often results in artifacts known as cross-color and cross-luminance.

A first type of low-cost PAL and NTSC decoders use horizontal band-pass/notch filters for Y/C separation. See pages 428433 in “Video demystified: a handbook for the digital engineer 3rd edition”, by K. Jack. Eagle Rock: LLH Technical Publishing, 2001. ISBN 1-878707-56-6. Here, the notch filter in the luminance path suppresses most of the chrominance, but attenuates the high-frequency luminance as well. Similarly, the band-pass filter in the chrominance path passes the chrominance, but also passes the high-frequency luminance. Hence, these decoders suffer from a loss of horizontal luminance resolution and strong cross-luminance and cross-color artifacts.

A second type, more advanced decoders aim at an improved Y/C separation by using so called comb-filters. See e.g. the article “Three-dimensional pre- and post-filtering for PAL TV signals”, by D. Teichner, in IEEE Transactions in Consumer Electronics, Vol. 34 (1988), No. 1, pp. 205-227. This type of decoders exploit the opposite sub-carrier phase of certain vertically or temporally adjacent samples to separate the luminance from the chrominance. The basic principle can be explained by taking a composite PAL sample, F₁ that is encoded at an arbitrary phase φ:
F₁=Y+U sin(φ)+V cos(φ) (1)
and a second sample F₂ encoded at 180°+φ, of which it is assumed that it was encoded from identical luminance and chrominance values:
F₂=Y+U sin(φ+180°)+V cos(φ+180°)
F₂=Y−U sin(φ)−V cos(φ) (2)
Now, the addition of F₁ and F₂ and subsequent division by two results in the separated luminance Y, whereas the subtraction and subsequent division by two yields the modulated chrominance U sin(φ)+V cos(φ). This means that perfect Y/C separation is possible if F₁ and F₂ were indeed encoded from highly correlated YUV values.

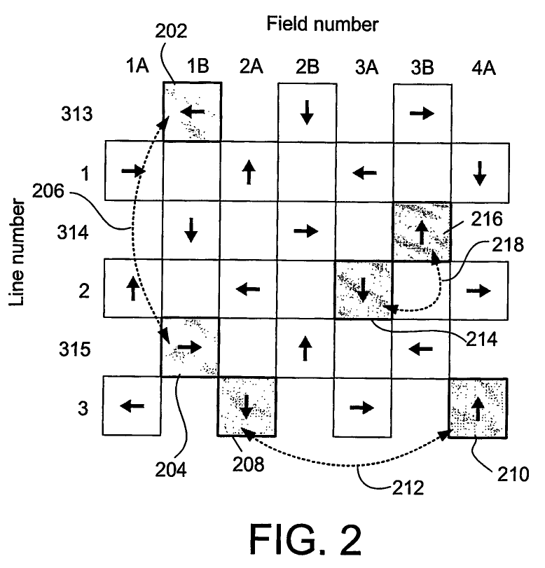

Current state-of-the-art comb-filters adaptively combine various spatial and temporal comb-filters by filtering along the direction of the highest detected correlation. See pages 115-118 in “Video-Signalverarbeitung”, by C. Hentschel. Stuttgart: Teubner, 1998. ISBN 3-519-06250X. (See also FIG. 2). However, particularly in vertically detailed and/or moving areas, the available comb-filtering directions are often too limited due to the required opposite sub-carrier phase. As such, even modern 3D comb-filters suffer from cross-talk artifacts and loss of resolution.

It is an object of the invention to provide a filter unit of the kind described in the opening paragraph with an improved luminance and color separation.

This object of the invention is achieved in that the filter unit comprises:

acquisition means to acquire a first sample of the composite color television signal, corresponding to a first pixel and other samples of the composite color television signal, corresponding to other pixels in a neighborhood of the first pixel;

correlation estimation means to estimate a first set of correlation values representing correlations between the first sample and the respective other samples, on basis of an initial separation of an approximation of the luminance signal from the composite color television signal;

penalty estimation means to estimate a second set of penalty values representing relations between the first sample and the respective other samples;

computing means to compute a third set of combined values by means of combining respective elements of the first set of correlation values and the second set of penalty values;

selection means to select a particular sample of the composite color television signal on basis of the corresponding combined value compared to further combined values of the third set of combined values; and

decoding means to determine at least one final value of a set of values comprising a final luminance value and two color values corresponding to the first pixel on basis of the first sample and the particular sample.

In prior art filter units, e.g. based on comb-filters, the selected decoding option, i.e. the particular sample, is only based on the correlation between the first sample and the particular sample. For the Y/C separation of the first sample in a standard two sample filter unit, an additional sample, with a predetermined sub-carrier phase difference compared to the first sample, is required. However the number of samples fulfilling that condition is relatively limited. Besides that, often, e.g. in the case of much image detail or motion, the actual correlation between the first sample and the particular sample is relatively small.

In the filter unit according to the invention, a more general approach is used by applying an extended set of candidate samples, i.e. decoding options. The selection of the most appropriate sample, i.e. the particular sample, is based on the correlation between the two first sample and the particular sample and based on a corresponding penalty value. Therefore, the first sample and the particular sample corresponding to a pixel within a predetermined spatial or temporal neighborhood of the pixel, corresponding to the first sample, are used as input for the two sample filter unit. The underlying principle of the filter unit according to the invention is that comb-filtering is most desirable on samples that exhibit the highest correspondence, regardless of their exact spatial or temporal direction. That means that there is a trade-off between a strict phase requirement, e.g. 180° difference, and correlation. E.g. a particular sample and the first sample might have non-opposite sub-carries phases, but a difference of sub-carries phases of e.g. 170°. In that case the particular sample might be chosen because of its high correlation value, although the difference of sub-carries phases is 170°. This approach offers a significant increase in decoding options, and thereby promises an increase in decoding quality.

In an embodiment according to the invention, the correlation estimation means is arranged to compute a first one of the correlation values by means of computing a difference between a first luminance value and a second luminance value, the first luminance value belonging to the first pixel and being represented by a first sample of the approximation of the luminance signal, the second luminance value belonging to a second one of the pixels in the neighborhood of the first pixel and being represented by a second sample of the approximation of the luminance signal. Alternatively, chrominance values are applied to estimate the first one of the correlation values. The approximation of the luminance signal is obtained by means of an initial Y/C separation being performed by an initial separation filter. This initial separation filter might be based on any known type of Y/C separation filter as discussed above, e.g. a horizontal band-pass/notch filters or a known comb-filter.

In an embodiment according to the invention, the penalty estimation means is arranged to compute a first one of the penalty values by means of computing a distance between the first pixel and a second one of the pixels in the neighborhood of the first pixel. The distance between pixels is an appropriate measure to determine the appropriateness of the corresponding samples to be applied for Y/C separation. The bigger the temporal or spatial difference the less appropriate the sample.

In an embodiment according to the invention, the penalty estimation means is arranged to compute a first one of the penalty values by means of:

computing a first difference between a first sub-carrier phase of the first sample of the composite color television signal, corresponding to the first pixel and a second sub-carrier phase of a first one of the other samples corresponding to other pixels in the neighborhood of the first pixel; and

computing a second difference between the first difference and a predetermined value.

For a two-sample filter unit the predetermined value corresponds to 180°. For a three-sample filter unit the predetermined value corresponds to 120°. In the latter case the decoding means are arranged to determine the final luminance value and the two color values corresponding to the first pixel on basis of the first sample, the particular sample and a further one of the other samples corresponding to other pixels in a neighborhood of the first pixel. The deviation from the optimum sub-carrier phase is a relatively good measure to determine the appropriateness of the corresponding samples to be applied for Y/C separation. The computation of the deviation from the optimum sub-carrier phase is straightforward.

In an embodiment according to the invention the other pixels in the neighborhood of the first pixel are located in a window which is centered around the first pixel and located in a first field to which the first pixel belongs. Alternatively, a first portion of the other pixels in the neighborhood of the first pixel are located in a first window which is centered around the first pixel and located in a first field to which the first pixel belongs and a second portion of the other pixels in the neighborhood of the first pixel are located in a second window which is located in a second field. The second window is centered around a central pixel. A first option is that the first pixel and the central pixel have mutually equal coordinates. A second option is that the first pixel and the central pixel are located along a motion trajectory. That means that the difference between the coordinates of the first pixel and the coordinates of the central pixel are determined by a motion vector, representing motion between parts of the first and second field. An advantage of applying multiple windows corresponding to multiple fields is that the probability of selecting an appropriate particular sample is relatively high.

It is a further object of the invention to provide an image processing apparatus of the kind described in the opening paragraph with an improved luminance and color separation.

This object of the invention is achieved in that the filter unit comprises:

acquisition means to acquire a first sample of the composite color television signal, corresponding to a first pixel and other samples of the composite color television signal, corresponding to other pixels in a neighborhood of the first pixel;

correlation estimation means to estimate a first set of correlation values representing correlations between the first sample and the respective other samples, on basis of an initial separation of an approximation of the luminance signal from the composite color television signal;

penalty estimation means to estimate a second set of penalty values representing relations between the first sample and the respective other samples;

computing means to compute a third set of combined values by means of combining respective elements of the first set of correlation values and the second set of penalty values;

selection means to select a particular sample of the composite color television signal on basis of the corresponding combined value compared to further combined values of the third set of combined values; and

decoding means to determine at least one final value of a set of values comprising a final luminance value and two color values corresponding to the first pixel on basis of the first sample and the particular sample.

Optionally, the image processing apparatus comprises a display device for displaying images being represented by the luminance signal and the two color signals. The image processing apparatus might be a TV.

It is a further object of the invention to provide a method of the kind described in the opening paragraph resulting in an improved luminance and color separation.

This object of the invention is achieved in that the method comprises:

acquiring a first sample of the composite color television signal, corresponding to a first pixel and other samples of the composite color television signal, corresponding to other pixels in a neighborhood of the first pixel;

estimating a first set of correlation values representing correlations between the first sample and the respective other samples, on basis of an initial separation of an approximation of the luminance signal from the composite color television signal;

estimating a second set of penalty values representing relations between the first sample and the respective other samples;

computing a third set of combined values by means of combining respective elements of the first set of correlation values and the second set of penalty values;

selecting a particular sample of the composite color television signal on basis of the corresponding combined value compared to further combined values of the third set of combined values; and

determining at least one final value of a set of values comprising a final luminance value and two color values corresponding to the first pixel on basis of the first sample and the particular sample.

It is a further object of the invention to provide a computer program product of the kind described in the opening paragraph resulting in an improved luminance and color separation.

This object of the invention is achieved in that, the computer program product, after being loaded, provides said processing means with the capability to carry out:

acquiring a first sample of the composite color television signal, corresponding to a first pixel and other samples of the composite color television signal, corresponding to other pixels in a neighborhood of the first pixel;

estimating a first set of correlation values representing correlations between the first sample and the respective other samples, on basis of an initial separation of an approximation of the luminance signal from the composite color television signal;

estimating a second set of penalty values representing relations between the first sample and the respective other samples;

computing a third set of combined values by means of combining respective elements of the first set of correlation values and the second set of penalty values;

selecting a particular sample of the composite color television signal on basis of the corresponding combined value compared to further combined values of the third set of combined values; and

determining at least one final value of a set of values comprising a final luminance value and two color values corresponding to the first pixel on basis of the first sample and the particular sample.

Modifications of the filter unit and variations thereof may correspond to modifications and variations thereof of the method described.

These and other aspects of the filter unit, of the image processing apparatus, of the method and of the computer program product according to the invention will become apparent from and will be elucidated with respect to the implementations and embodiments described hereinafter and with reference to the accompanying drawings, wherein:

FIG. 1 schematically shows a spectrum of a composite PAL video signal;

FIG. 2 schematically show sub-carrier phases of samples in adjacent video lines for successive fields;

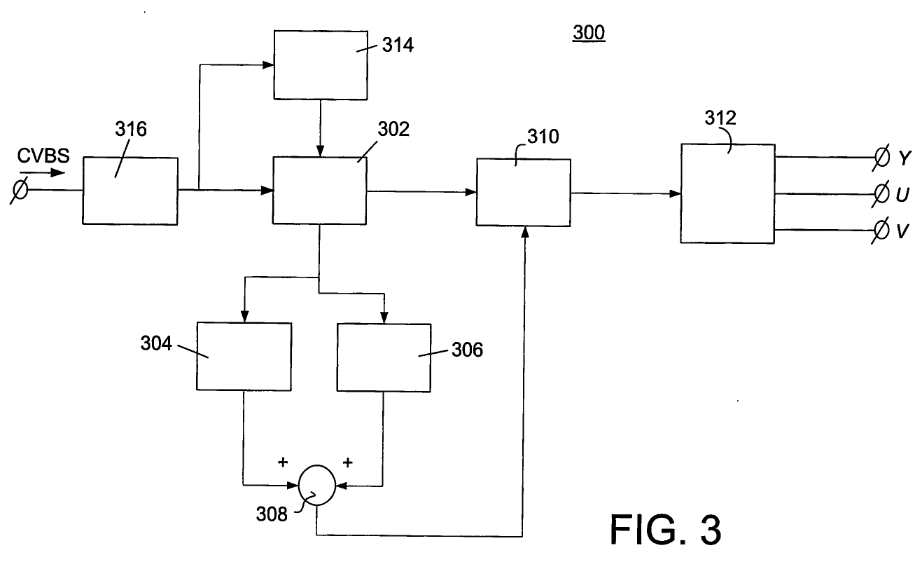

FIG. 3 schematically shows an embodiment of a filter unit according to the invention;

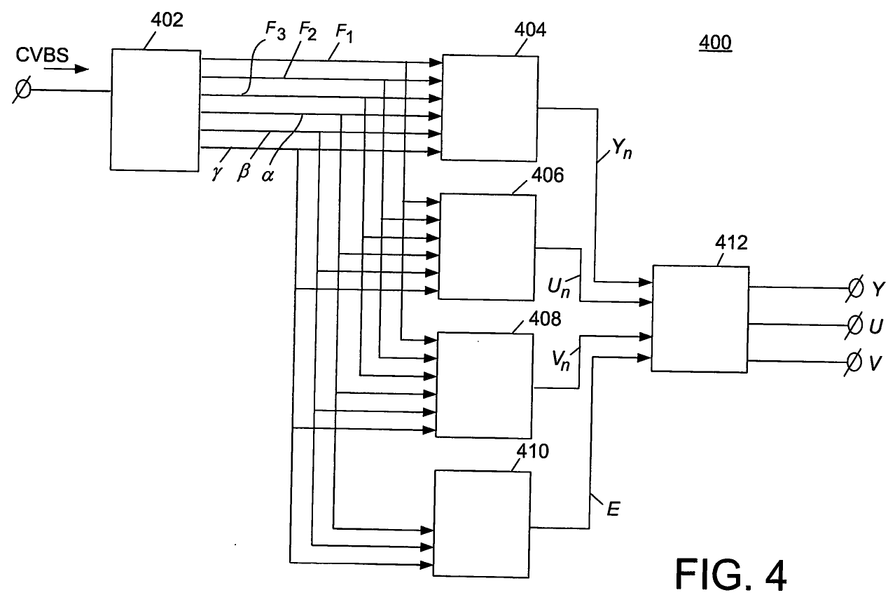

FIG. 4 schematically shows another embodiment of a filter unit according to the invention which is based on a three sample decoding scheme;

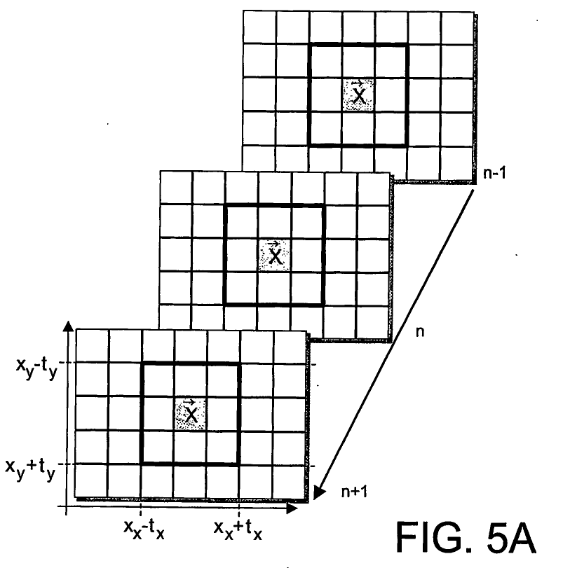

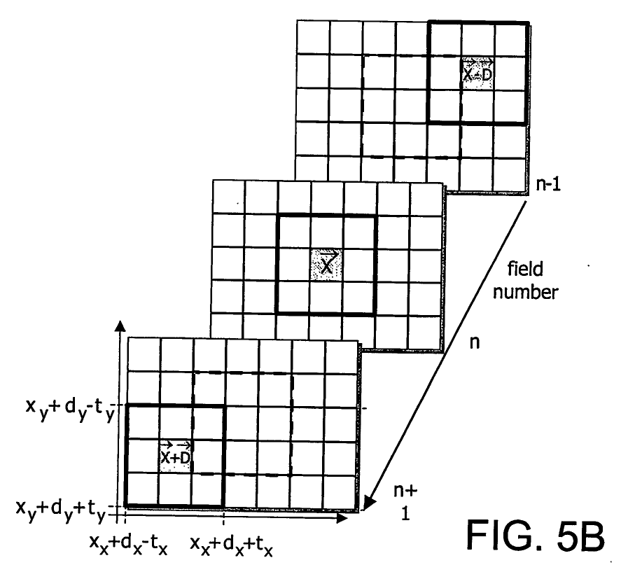

FIG. 5A schematically shows candidate windows in the next, current and previous fields at fixed position;

FIG. 5B schematically shows candidate windows in the next, current and previous fields at motion compensated position;

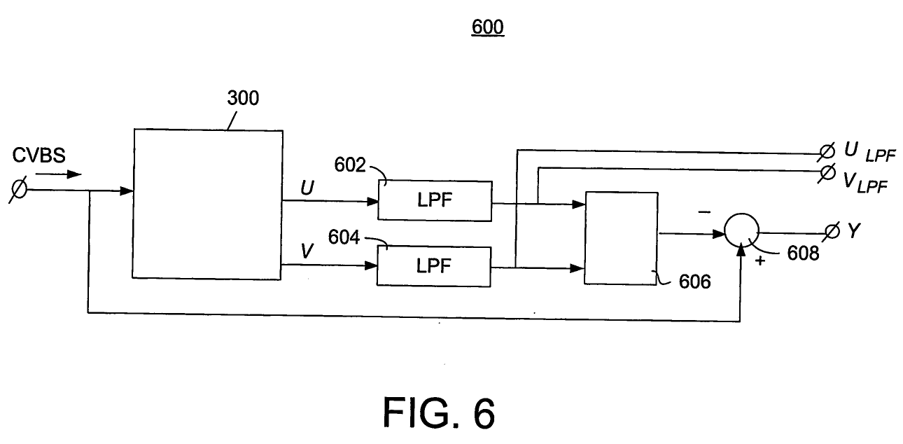

FIG. 6 schematically shows another embodiment of a filter unit according to the invention which is arranged to derive the luminance signal from decoded chrominance; and

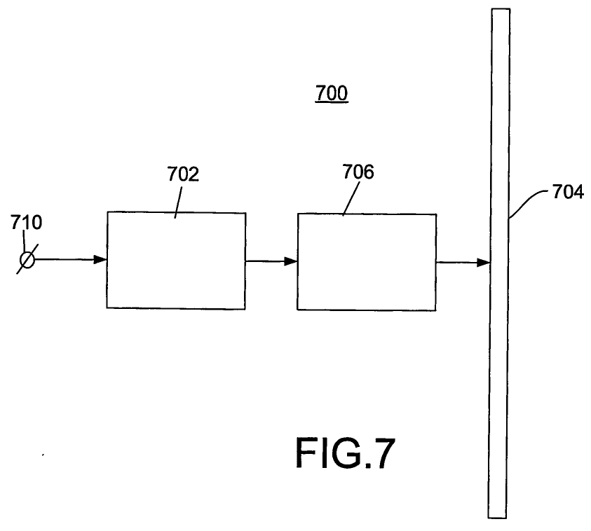

FIG. 7 schematically shows an image processing apparatus according to the invention.

Same reference numerals are used to denote similar parts throughout the figs.

FIG. 1 schematically shows a spectrum of a composite PAL video signal.

In order to comprehend the problems involved in Y/C separation, one has to understand the standards for the transmission of analog color television signals, such as the PAL, NTSC and SECAM standards described in ITU-R BT.470. For these standards, the requirement of backward compatibility to existing black-and-white televisions dictates that the transmission of chrominance (C) has to take place within the band available for the gray-scales (Y).

For PAL, the chrominance components U and V are amplitude modulated in quadrature onto a sub-carrier frequency of 4.43 MHz The resulting one-dimensional spectrum of the composite PAL video signal is illustrated in FIG. 1. In addition, the sign of the V-component, the so-called V-switch, is inverted every other line to reduce the influence of phase errors. More formally, the above is described in Equation 3, where \vec{x} indicates the pixel position in a given field n, F_{sc} the sub-carrier frequency and F the resulting composite PAL signal.
F(\vec{x},n)=Y(\vec{x},n)+U(\vec{x},n)sin(2πF_{sc}t)±V(\vec{x},n)cos(2πF_{sc}t) (3)

For NTSC, the somewhat differently defined chrominance components I and Q are amplitude modulated in quadrature onto a sub-carrier frequency of 3.58 MHz. As no alternating sign is applied to either chrominance component, there is an increased sensitivity to phase errors that can result in an erroneous hue of the decoded picture. The one-dimensional spectrum is similar to that of PAL, except that now the available video bandwidth is limited to approximately 4.2 MHz. Equation 4 formally defines NTSC encoding:
F(\vec{x},n)=Y(\vec{x},n)+I(\vec{x},n)sin(2πF_{sc}t)+Q(\vec{x},n)cos(2πF_{sc}t) (4)
The remainder of this specification discusses the Y/C separation of PAL composite color video signals. However, the Y/C separation of NTSC signals is nearly identical to the described separation of PAL signals with equal V-switches. First a short description of prior art Y/C separation filters is provided.

At the television receiver, the required separation of Y and C can only be imperfect as both components share the same frequency space. The early decoders for PAL and NTSC composite video signals used two simple one-dimensional horizontal filters to separate luminance and chrominance from the composite signal. These filters are so-called notch and band-pass filters.

In the luminance path, a notch filter suppresses frequencies near the sub-carrier frequency to eliminate horizontal chrominance components. Due to the small stop band of the notch filter, high-frequency chrominance components, as they occur on horizontal colored transitions, will be insufficiently attenuated. This introduces cross-talk from chrominance to luminance, resulting in the so-called cross-luminance artifacts. Furthermore, the luminance resolution is significantly reduced, as the notch filter suppresses any luminance components in the stop-band.

In the chrominance path, a band-pass filter separates the high frequency components from the composite signal. Although the pass-band of the band-pass filter contains mostly chrominance information, high-frequency luminance is present as well. Again, cross-talk will occur as the high-frequency luminance will be decoded as chrominance, resulting in the so-called cross-color artifacts.

The band-pass and notch filters can achieve perfect Y/C separation if the luminance and chrominance values of horizontally adjacent samples are identical, as here the frequency spectrum consists of a DC luminance component and a chrominance component at the sub-carrier frequency. However, if the correlation along the horizontal axis is insufficient, the frequency spectrum contains high-frequency luminance and/or chrominance components. The horizontal separation is now imperfect and results in cross-talk artifacts in the decoded signal.

In areas where horizontally adjacent samples are insufficiently correlated, additional methods for Y/C separation are desirable. For that purpose, so-called comb-filters can be used to separate luminance and chrominance along the vertical or temporal axis. Their underlying principles are similar to those of the standard decoder, i.e. passing the desired frequency components and suppressing the undesired frequency components.

However, the luminance and chrominance are now modulated with harmonics of fₕ, i.e. the line frequency, and fᵥ, i.e. the picture frequency. Along with the chosen sub carrier frequencies of PAL and NTSC, this results in interleaved and non-overlapping luminance and chrominance frequency components in the direction where sufficient correlation is present. For example, in non-moving areas of the picture, the samples are highly correlated along the temporal axis, and as such, the luminance and chrominance components are interleaved and non-overlapping along that axis. A filter with a comb-shaped amplitude response in that particular direction can therefore be used to separate the luminance and chrominance.

A typical comb-filter implementation uses two samples with an opposite relative phases, i.e. having a phase difference of 180° to separate luminance and chrominance. See Equations 1 and 2.

However, perfect separation is only possible if both composite samples were encoded from identical Y, U and V values. Only in this case, the positions of the luminance and chrominance frequency components correspond to those of the comb-filter. Therefore, sufficient correlation is required along the comb-filtering direction in order to prevent decoding errors. This is analogous to the horizontal band-pass/notch filters, where sufficient correlation is required along the horizontal axis.

An inherent drawback of the standard comb-filter is the low density of samples that both meet the required phase relationship, and are spatially and/or temporally adjacent. Due to this limited set of samples, situations will occur where neither of the neighboring samples exhibit sufficient correlation with respect to the current sample, thereby causing artifacts in the decoded video.

FIG. 2 schematically show sub-carrier phases of samples 202, 204, 208, 210, 214 and 216 in adjacent video lines 313, 1, 314, 2, 315 and 3 for successive fields 1A, 1B, 2A, 2B, 3A, 3B and 4A. Here, the arrow equals the sub-carrier phase, e.g. pointing up denotes 0° and to the right denotes 90°. Besides that, pairs of samples 206, 212 and 218 are depicted which are used for standard comb-filters:

the pair 206 of samples 202 and 204 correspond to a line comb-filter;

the pair 212 of samples 208 and 210 correspond to a frame comb-filter; and

the pair 218 of samples 214 and 216 correspond to a field comb-filter.

FIG. 3 schematically shows an embodiment of a filter unit 300 according to the invention. In particular FIG. 3 schematically shows a PAL decoder. The filter unit 300 is provided with a composite color television signal CVBS, comprising a chrominance signal being modulated on a sub-carrier which is located in the high-frequency part of the frequency spectrum of the luminance signal. The output of the filter unit 300 comprises a luminance signal Y, a first color signal U and a second color signal V. The filter unit 300 comprises:

an acquisition unit 302 to acquire a first sample of the composite color television signal, corresponding to a first pixel and other samples of the composite color television signal, corresponding to other pixels in a neighborhood of the first pixel;

a correlation estimation unit 304 to estimate a first set of correlation values representing correlations between the first sample and the respective other samples, on basis of an initial separation of an approximation of the luminance signal from the composite color television signal;

a penalty estimation unit 306 to estimate a second set of penalty values representing relations between the first sample and the respective other samples;

a computing unit 308 to compute a third set of combined values by means of combining respective elements of the first set of correlation values and the second set of penalty values;

a selection unit 310 to select a particular sample of the composite color television signal on basis of the corresponding combined value compared to further combined values of the third set of combined values;

a decoding unit 312 to determine at least one final value of a set of values comprising a final luminance value and two color values corresponding to the first pixel on basis of the first sample and the particular sample. This decoding unit might be any known type of PAL decoding filter, e.g. based on a comb-filter; and

an initial separation filter 314.

The sample acquisition unit 302, the correlation estimation unit 304, penalty estimation unit 306, the computing unit 308, the selection unit 310, the decoding unit 312 and the initial separation filter 314 may be implemented using one processor. Normally, these functions are performed under control of a software program product. During execution, normally the software program product is loaded into a memory, like a RAM, and executed from there. The program may be loaded from a background memory, like a ROM, hard disk, or magnetically and/or optical storage, or may be loaded via a network like Internet. Optionally an application specific integrated circuit provides the disclosed functionality.

Next the working of the filter unit 300 according to the invention will be explained. An important aspect of the filter unit 300 is the selection of related samples. This selection is based upon characteristics of the composite color television signal CVBS. In this case the selection is performed on a per-sample basis. That means that for every first sample to be decoded, the most suitable additional sample, i.e. the particular sample is chosen. The most suitable sample is determined by:

the correlation value, being computed by the correlation estimation unit 304, as insufficiently correlated samples yield decoding errors; and

the penalty value, being computed by the penalty estimation unit 306. The penalty is based on a phase measurement and optionally a distance measurement. Spatially and/or temporally adjacent samples are generally expected to have a higher correlation to the current sample than non-adjacent samples. As such, larger spatial and/or temporal distances should be avoided.

With phase, optionally distance and correlation information available, a straightforward approach is to apply the criteria to spatially and/or temporally adjacent samples: the so-called candidate set, which is generated by means of the acquisition unit 302. The optimum sample or candidate, being selected by means of the selection unit 310 within that candidate set serve as input to the decoding unit 312, thereby decoding the current CVBS sample.

However, determining the correlation between samples constitutes a chicken-or-the-egg problem: in order to decode the color television signal CVBS, one needs to know the correlation between samples, which in turn is only available after decoding. To break this cycle, the filtering is initialized by an initial separation, which is performed by the initial separation filter 314 which is based on e.g. a combination of horizontal band-pass/notch filters. Even though this initial separation is far from perfect, experimental validation has shown its suitability for this purpose.

The exact size of the candidate window is determined by the horizontal and vertical boundaries tₓ and t_{y}, as shown in Equation 5. Again, F(\vec{x}, n) is the composite sample at the pixel position \vec{x} in a given field n.

$$\begin{matrix}C ( \vec{x} , n + m ) = \{ F \text{(} \vec{x} + ( \begin{matrix}i \\ j\end{matrix} ) , n + m \text{)} \} \\ with \text{:} & ( 5 ) \\ i ∈ \{ - {t}_{x} , … , {t}_{x} \} , j ∈ \{ - {t}_{y} , … , {t}_{y} \} & ( 6 )\end{matrix}$$

If only spatial candidates are used, i.e. m=0, this leads to Equation 7, i.e. the complete candidate set CS equals the spatial candidate set C(\vec{x}, n).
CS={C(\vec{x},n)} (7)

However, CS might be composed of spatial as well as temporal candidates. For example, consider the candidate set shown in Equation 8 and FIG. 5A, where candidates originate from candidate windows in the previous, current and next field.
CS={C(\vec{x},n+1), C(\vec{x},n), C(\vec{x},n−1)} (8)

As opposed to temporal windows centered around the current spatial position, motion compensation is preferably used to increase the correlation of temporal candidates by positioning the candidate windows along the motion axis. This is illustrated in Equation 9 and FIG. 5B, where D(\vec{x}, n) describes the displacement of the sample at pixel position \vec{x} in a filed field n to field n+1. The displacement from field n to n−1 is assumed to be −D(\vec{x}, n), i.e. linear movement.

$$CS = \{ \begin{matrix}C ( \vec{x} + D ( \vec{x} , n ) , n + 1 ) , \\ C ( \vec{x} , n ) , \\ C ( \vec{x} - D ( \vec{x} , n ) , n - 1 )\end{matrix} \} \qquad ( 9 )$$

Due to the increase in latency, comb-filters using a next field can be undesirable. Therefore, various configurations are possible using only previous fields. Three examples are illustrated in Equation 10, where respectively frame and field, field only and frame only comb-filters are specified.

$$CS = \{ C ( \vec{x} , n ) , C ( \vec{x} , n - 1 ) , C ( \vec{x} , n - 2 ) \} \\ CS = \{ C ( \vec{x} , n ) , C ( \vec{x} , n - 1 ) \} \\ CS = \{ C ( \vec{x} , n ) , C ( \vec{x} , n - 2 ) \} \qquad ( 10 )$$

The computation of the combined value, based on the correlation and phase is as follows. Given a candidate set CS of CSAFAX candidates, a combined value is assigned to each candidate as a function of both the phase relationship and the correlation to the current sample. This is shown in Equation 11, where the combined value ε₁ is calculated for the respective candidates CS₁ with iε{i, . . . , CSMAX}. The combined value equals the weighted sum of the correlation value L(CS₁, F₁) and the phase penalty P(CS₁) where α₁ and α₂ correspond to the respective weighting factors:
ε₁(CS₁,F₁)=α₁·L(CS₁,F₁)+α₂·P(CS₁) (11)
with:
F₁=F(\vec{x}, n) (12)

The correlation value is calculated in a straightforward manner as the absolute difference of the initially separated luminance values, as shown in Equation 13.
L(CS₁, F₁)=|Yᵢₙᵢₜ(F₁)−Yᵢₙᵢₜ(CS₁)| (13)

The basic idea behind the phase penalty is that the phase differences that result in no amplification of correlation noise should yield the lowest penalty. For the two sample comb-filter kernel, the situation is simplified as strict phase requirements exist. In the case of identical V-switches, a two sample comb-filter requires an opposite relative phase, i.e. a difference of 180°, whereas in case of non-identical V-switches, comb-filtering using two samples is only possible if the samples' absolute phases are opposite.

First, the sub-carrier phase of F₁ is specified as ∠(F₁). The normalized phase difference βₙ which transforms the relative phase β from [0,2π] is determined according to:

$$β = \vert ∠ ( {CS}_{i} ) - ∠ ( {F}_{1} ) \vert \\ {β}_{n} = \{ \begin{matrix}2 π - β & , if & {β}_{n} > π \\ β & & , else\end{matrix} \qquad ( 14 )$$

Then the phase penalty for samples with identical V-switches can be defined:

$$P ( {CS}_{i} ) = \{ \begin{matrix}0 & , if & {β}_{n} = π \\ 1 & & , else\end{matrix} \qquad ( 15 )$$

In turn, the phase penalty for samples with non-identical V-switches is:

$$P ( {CS}_{i} ) = \{ \begin{matrix}0 & , if & ∠ ( {CS}_{i} ) = - ∠ ( {F}_{1} ) \\ 1 & & , else\end{matrix} \qquad ( 16 )$$

Having determined the penalties for the CSMAX candidates within candidate set CS, the optimum candidate, i.e. the one with the lowest combined value, will be selected as the particular sample F₂. Both F₁ and F₂ can now be decoded by the two sample comb-filter kernel, i.e. the decoding unit 312.

Optionally the filter unit 300 comprises an up-sampling unit 316 which is designed to achieve an increased density of the sampling grid by means of interpolation. Within a certain spatial distance, now k times as many candidates are available in comparison to the original sampling grid, with k being the up-sampling factor. Therefore, the amount of candidates has increased, whereas a deterioration of correlation due to increased spatial distance has been avoided.

Besides decoding based on two samples, there are decoding techniques based on three samples. A filter unit according to the invention of this latter type is described in connection with FIG. 4. First the decoding based on three samples is explained and then the method of selecting three appropriate samples.

FIG. 4 schematically shows another embodiment of a filter unit according to the invention, which is based on a three sample decoding scheme. The filter unit 400 is provided with a composite color television signal CVBS, comprising a chrominance signal being modulated on a sub-carrier which is located in the high-frequency part of the frequency spectrum of the luminance signal. The output of the filter unit 400 comprises a luminance signal Y, a first color signal U and a second color signal V. The filter unit 400 comprises:

a sample acquisition unit 402 which is arranged to acquire a first F₁, a second F₂ and a third F₃ sample from the received composite color television signal CVBS and to regenerate three signals α, β and γ corresponding to the sub-carrier used for encoding of the video data;

a first processing unit 404 for computing a first intermediate signal Yₙ;

a second processing unit 406 for computing a second intermediate signal Uₙ;

a third processing unit 408 for computing a third intermediate signal Vₙ;

a fourth processing unit 410 for computing a fourth intermediate signal E; and

a division unit 412 for computing the luminance signal Y, the first color signal U and the second color signal V on basis of the intermediate signals Yₙ, Uₙ, Vₙ and E.

The filter unit 400 is arranged to compute an output luminance value of a particular output pixel, a first color value of the particular output pixel and a second color value of the particular output pixel on basis a first F₁, a second F₂ and a third F₃ sample derived from the composite color television signal CVBS, where the first, the second and the third sample have mutually different sub-carrier phases.

A received composite sample, F(\vec{x}, n) introduces three unknown variables, namely the values of Y, U and V, and one known value, i.e. the locally regenerated sub-carrier phase ωt. Basic algebra shows that, given three linear equations, these three unknown variables can be solved. This means that three composite samples, encoded from Y, U and V values, can be used to separate the Y, U and V components exactly. However, in the situation that the composite samples were encoded from non-identical Y, U and V values, perfect separation is not possible and errors in the decoded values will occur.

To discuss the decoding of samples with non-opposite phases in more detail, two situation with respect to the V-switch of three composite samples should be considered:

The V-switch of all three samples is identical; or

One of the three samples has an unequal V-switch with respect to the other samples.

Therefore a distinction between the decoding of samples with identical V-switches, and the decoding of samples with non-identical V-switches is made. Although the following calculations are applicable to PAL signals, identical principles apply to NTSC as to PAL signals with identical V-switches. Then, the chrominance components I and Q are used instead of U and V.

In the case of identical V-switches, consider three composite samples encoded from the same Y, U and V values as shown in Equation 17. In order to obtain three independent equations, the phases were chosen to be unequal, i.e. α≠β≠γ. Also, the V-switch of all V components is chosen to be positive. In the case of all negative V-switches, the situation is identical expect for an inversion of the sign of the decoded V component

$${F}_{1} = Y + U \cdot sin ( α ) + V \cdot cos ( α ) \\ {F}_{2} = Y + U \cdot sin ( β ) + V \cdot cos ( β ) \\ {F}_{3} = Y + U \cdot sin ( γ ) + V \cdot cos ( γ ) \qquad ( 17 )$$

By solving these three linear equations for the Y, U and V components, the expressions in Equations 18 and 19 are obtained. Here, the Y, U and V components are expressed in terms of the three original composite samples and their corresponding sub-carrier phase.

$$\begin{matrix}{Y}_{n} = \begin{matrix}+ {F}_{1} \cdot sin ( β ) \cdot cos ( γ ) - {F}_{1} \cdot sin ( γ ) \cdot cos ( β ) \\ + {F}_{2} \cdot sin ( γ ) \cdot cos ( α ) - {F}_{2} \cdot sin ( α ) \cdot cos ( γ ) \\ + {F}_{3} \cdot sin ( α ) \cdot cos ( β ) - {F}_{3} \cdot sin ( β ) \cdot cos ( α )\end{matrix} \\ {U}_{n} = \begin{matrix}+ {F}_{1} \cdot cos ( β ) - {F}_{1} \cdot cos ( γ ) + {F}_{2} \cdot cos ( γ ) \\ - {F}_{2} \cdot cos ( α ) + {F}_{3} \cdot cos ( α ) - {F}_{3} \cdot cos ( β )\end{matrix} \\ {V}_{n} = \begin{matrix}+ {F}_{1} \cdot sin ( γ ) - {F}_{1} \cdot sin ( β ) + {F}_{2} \cdot sin ( α ) \\ - {F}_{2} \cdot sin ( γ ) + {F}_{3} \cdot sin ( β ) - {F}_{3} \cdot sin ( α )\end{matrix} \\ E = \begin{matrix}+ sin ( α ) \cdot cos ( β ) - sin ( α ) \cdot cos ( γ ) \\ + sin ( β ) \cdot cos ( γ ) - sin ( β ) \cdot cos ( α ) \\ + sin ( γ ) \cdot cos ( α ) - sin ( γ ) \cdot cos ( β )\end{matrix} \\ with \text{:} & ( 18 ) \\ Y = \frac{{Y}_{n}}{E} , U = \frac{{U}_{n}}{E} , V = \frac{{V}_{n}}{E} & ( 19 )\end{matrix}$$

A similar calculation can be performed for samples with non-identical V-switches. Two situations can be distinguished:

The V-switch of one composite sample is positive, whereas the remaining samples have a negative V-switch; or

The V-switch of one composite sample is negative, whereas the remaining samples have a positive V-switch.
The first situation is shown in Equation 20, whereas the second situation will not be covered, as it is identical except for an inversion in sign of the decoded V component.

$${F}_{1} = Y + U \cdot sin ( α ) + V \cdot cos ( α ) \\ {F}_{2} = Y + U \cdot sin ( β ) + V \cdot cos ( β ) \\ {F}_{3} = Y + U \cdot sin ( γ ) + V \cdot cos ( γ ) \qquad ( 20 )$$

By solving these equations for the Y, U and V components, the expressions depicted in Equations 21 and 22 can be obtained.

$$\begin{matrix}{Y}_{n} = \begin{matrix}+ {F}_{1} \cdot sin ( β ) \cdot cos ( γ ) - {F}_{1} \cdot sin ( γ ) \cdot cos ( β ) \\ - {F}_{2} \cdot sin ( γ ) \cdot cos ( α ) - {F}_{2} \cdot sin ( α ) \cdot cos ( γ ) \\ + {F}_{3} \cdot sin ( α ) \cdot cos ( β ) + {F}_{3} \cdot sin ( β ) \cdot cos ( α )\end{matrix} \\ {U}_{n} = \begin{matrix}+ {F}_{1} \cdot cos ( β ) - {F}_{1} \cdot cos ( γ ) + {F}_{2} \cdot cos ( γ ) \\ + {F}_{2} \cdot cos ( α ) - {F}_{3} \cdot cos ( α ) - {F}_{3} \cdot cos ( β )\end{matrix} \\ {V}_{n} = \begin{matrix}+ {F}_{1} \cdot sin ( β ) - {F}_{1} \cdot sin ( γ ) + {F}_{2} \cdot sin ( γ ) \\ - {F}_{2} \cdot sin ( α ) + {F}_{3} \cdot sin ( α ) - {F}_{3} \cdot sin ( β )\end{matrix} \\ E = \begin{matrix}+ sin ( α ) \cdot cos ( β ) - sin ( α ) \cdot cos ( γ ) \\ + sin ( β ) \cdot cos ( γ ) + sin ( β ) \cdot cos ( α ) \\ - sin ( γ ) \cdot cos ( α ) - sin ( γ ) \cdot cos ( β )\end{matrix} \\ With \text{:} & ( 21 ) \\ Y = \frac{{Y}_{n}}{E} , U = \frac{{U}_{n}}{E} , V = \frac{{V}_{n}}{E} & ( 22 )\end{matrix}$$

Next the computation of penalty values in the case of three samples is specified. In the case of identical V-switches the phase penalty value is specified by Equation 23:

$$P ( {CS}_{1} ) = \{ \begin{matrix}0 & , if {β}_{n} = π \\ \frac{3 {β}_{n} - 2 π}{π} & , if \frac{2 π}{3} < {β}_{n} > π \\ \frac{2 π - 3 {β}_{n}}{π} & , if \frac{π}{3} < {β}_{n} \leq \frac{2 π}{3} \\ 1 & , else \end{matrix} \qquad ( 23 )$$

In the case of non-identical V-switches the phase penalty value is specified in Equation 25 for 0<α≦π/2, whereas the penalty for the other three quadrants, i.e. between π/2, π, 3π/2 and 2π can be mapped to the first quadrant by means of αₙ:

$$\begin{matrix}{α}_{n} = \{ \begin{matrix}2 π - α & , if \frac{3 π}{2} < α \leq 2 π \\ α - π & , if π < α \leq \frac{3 π}{2} \\ π - α & , if \frac{π}{2} < α \leq π \\ α & , else \end{matrix} & ( 24 ) \\ P ( {CS}_{1} ) = \{ \begin{matrix}0 & , if {β}_{n} = π \\ \frac{3 {β}_{n} - 2 π}{π} & , if \frac{2 π}{3} < {β}_{n} > π \\ \frac{2 π - 3 {β}_{n}}{π} & , if \frac{π}{3} < {β}_{n} \leq \frac{2 π}{3} \\ 1 & , else \end{matrix} \\ with & ( 25 ) \\ \begin{matrix}{S}_{1} \text{:} & ∠ ( {CS}_{1} ) = - α \\ {S}_{2} \text{:} & ( 0 \leq {α}_{n} < \frac{π}{4} ) ⋀ ( 2 {π}_{n} < {β}_{n} < \frac{π}{2} ) \\ {S}_{3} \text{:} & ( \frac{π}{2} \leq {α}_{n} < \frac{π}{2} ) ⋀ ( \frac{π}{2} < {β}_{n} < 2 {π}_{n} )\end{matrix} & ( 26 )\end{matrix}$$

FIG. 6 schematically shows another embodiment of a filter unit according to the invention which is arranged to derive the luminance signal from decoded chrominance. The filter unit 600 according to the invention comprises:

a first low pass filter 602 for filtering a first U one of the two color signals;

a second low pass filter 604 for filtering a second V one of the two color signals;

a modulator 606 connected to the first low pass filter 602 and the second low pass filter 604, for remodulating the filtered first U_{LPF} one of the two color signals and the filtered second V_{LPF} one of the two color signals; and

a subtraction unit 608 for subtracting the output of the modulator 606 from the composite color television signal CVBS, resulting in a luminance signal Y.

The first 602 and second low pass filter 604 have a characteristic which matches the low pass filters being applied in PAL encoders, i.e. 1.3 MHz and the modulator 606 is arranged to modulate with a sub-carrier being applied in PAL encoders. In this embodiment according to the invention the two filtered color signals U_{LPF} and V_{LPF} do not or hardly comprise frequency components which were not present in the original color signals before encoding. Furthermore, the luminance signal also better matches the original luminance signal before encoding by a video encoding unit, i.e. a PAL encoder.

A further improvement of the filter unit according to the invention is based on dynamic window resizing. Dynamic window resizing can achieve a reduction in computational cost and prevent decoding errors due to an erroneous initialization. In flat areas, i.e. in case of highly correlated samples, the candidate window size will be decreased to avoid any errors due to inaccuracies in the initialization. In areas with a significant amount of detail, an enlargement of the window size is necessary to ensure sufficient correlated candidates are available to the comb-filter.

FIG. 7 schematically shows an image processing apparatus 700 according to the invention, comprising:

Receiving means 302 for receiving a signal representing input images.

The filter unit 706 as described in connection with any of the FIGS. 3, 4 and 6; and

A display device 704 for displaying images being represented by the luminance signal and the two color signals.

The signal may be a broadcast signal received via an antenna or cable but may also be a signal from a storage device like a VCR (Video Cassette Recorder) or Digital Versatile Disk (DVD). The signal is provided at the input connector 710. The image processing apparatus 700 might e.g. be a TV. Alternatively the image processing apparatus 704 does not comprise the optional display device but provides the output images to an apparatus that does comprise a display device 704. Then the image processing apparatus 700 might be e.g. a VCR player. Optionally the image processing apparatus 700 comprises storage means, like a hard-disk or means for storage on removable media, e.g. optical disks.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware.

1. A luminance and color separation filter unit (300) for extracting a luminance signal (Y) and two color signals (U, V) from a composite color television signal (CVBS), comprising a chrominance (C) signal being modulated on a sub-carrier which is located in the high-frequency part of the frequency spectrum of the luminance signal (Y), the filter unit (300) comprising:
acquisition means (302) to acquire a first sample of the composite color television signal, corresponding to a first pixel and other samples of the composite color television signal, corresponding to other pixels in a neighborhood of the first pixel;
correlation estimation means (304) to estimate a first set of correlation values representing correlations between the first sample and the respective other samples, on basis of an initial separation of an approximation of the luminance signal from the composite color television signal;
penalty estimation means (306) to estimate a second set of penalty values representing relations between the first sample and the respective other samples;
computing means (308) to compute a third set of combined values by means of combining respective elements of the first set of correlation values and the second set of penalty values;
selection means (310) to select a particular sample of the composite color television signal on basis of the corresponding combined value compared to further combined values of the third set of combined values; and
decoding means (312) to determine at least one final value of a set of values comprising a final luminance value and two color values corresponding to the first pixel, on basis of the first sample and the particular sample.

2. A luminance and color separation filter unit (300) as claimed in claim 1, whereby the correlation estimation means (304) is arranged to compute a first one of the correlation values by means of computing a difference between a first luminance value and a second luminance value, the first luminance value belonging to the first pixel and being represented by a first sample of the approximation of the luminance signal, the second luminance value belonging to a second one of the pixels in the neighborhood of the first pixel and being represented by a second sample of the approximation of the luminance signal.

3. A luminance and color separation filter unit (300) as claimed in claim 1, whereby the penalty estimation means (306) is arranged to compute a first one of the penalty values by means of computing a distance between the first pixel and a second one of the pixels in the neighborhood of the first pixel.

4. A luminance and color separation filter unit (300) as claimed in claim 1, whereby the penalty estimation means (306) is arranged to compute a first one of the penalty values by means of:
computing a first difference between a first sub-carrier phase of the first sample of the composite color television signal, corresponding to the first pixel and a second sub-carrier phase of a first one of the other samples corresponding to other pixels in the neighborhood of the first pixel; and
computing a second difference between the first difference and a predetermined value.

5. A luminance and color separation filter unit (300) as claimed in claim 4, whereby the predetermined value corresponds to 180°.

6. A luminance and color separation filter unit (300) as claimed in claim 4, whereby the predetermined value corresponds to 120° and the decoding means (312) are arranged to determine the at least one final value of the set of values comprising the final luminance value and the two color values corresponding to the first pixel, on basis of the first sample, the particular sample and a further one of the other samples corresponding to other pixels in a neighborhood of the first pixel.

7. A luminance and color separation filter unit (300) as claimed in claim 1, whereby the other pixels in the neighborhood of the first pixel are located in a window which is centered around the first pixel and located in a first field to which the first pixel belongs.

8. A luminance and color separation filter unit (300) as claimed in claim 1, whereby a first portion of the other pixels in the neighborhood of the first pixel are located in a first window which is centered around the first pixel and located in a first field to which the first pixel belongs and a second portion of the other pixels in the neighborhood of the first pixel are located in a second window which is located in a second field.

9. A luminance and color separation filter unit (300) as claimed in claim 8, whereby the second window is centered around a central pixel, the first pixel and the central pixel having mutually equal coordinates.

10. A luminance and color separation filter unit (300) as claimed in claim 8, whereby the second window is centered around a central pixel, the difference between the coordinates of the first pixel and the coordinates of the central pixel determined by a motion vector, representing motion between parts of the first and second field.

11. An image processing apparatus (700) comprising:
receiving means (702) for receiving a composite color television signal, comprising a chrominance signal being modulated on a sub-carrier which is located in the high-frequency part of the frequency spectrum of a luminance signal; and
a luminance and color separation filter unit (706) for extracting the luminance signal and two color signals from the composite color television signal, the filter unit (706) comprising:
acquisition means (302) to acquire a first sample of the composite color television signal, corresponding to a first pixel and other samples of the composite color television signal, corresponding to other pixels in a neighborhood of the first pixel;
correlation estimation means (304) to estimate a first set of correlation values representing correlations between the first sample and the respective other samples, on basis of an initial separation of an approximation of the luminance signal from the composite color television signal;
penalty estimation means (306) to estimate a second set of penalty values representing relations between the first sample and the respective other samples;
computing means (308) to compute a third set of combined values by means of combining respective elements of the first set of correlation values and the second set of penalty values;
selection means (310) to select a particular sample of the composite color television signal on basis of the corresponding combined value compared to further combined values of the third set of combined values; and
decoding means (312) to determine at least one final value of a set of values comprising a final luminance value and two color values corresponding to the first pixel on basis of the first sample and the particular sample.

12. An image processing apparatus (800) as claimed in claim 11, further comprising a display device (804) for displaying images being represented by the luminance signal and the two color signals.

13. A TV comprising the image processing apparatus (800) as claimed in claim 12

14. A method of extracting a luminance signal and two color signals from a composite color television signal, comprising a chrominance signal being modulated on a sub
carrier which is located in the high-frequency part of the frequency spectrum of the luminance signal, the method comprising:
acquiring a first sample of the composite color television signal, corresponding to a first pixel and other samples of the composite color television signal, corresponding to other pixels in a neighborhood of the first pixel;
estimating a first set of correlation values representing correlations between the first sample and the respective other samples, on basis of an initial separation of an approximation of the luminance signal from the composite color television signal;
estimating a second set of penalty values representing relations between the first sample and the respective other samples;
computing a third set of combined values by means of combining respective elements of the first set of correlation values and the second set of penalty values;
selecting a particular sample of the composite color television signal on basis of the corresponding combined value compared to further combined values of the third set of combined values; and
determining at least one final value of a set of values comprising a final luminance value and two color values corresponding to the first pixel on basis of the first sample and the particular sample.

15. A computer program product to be loaded by a computer arrangement, comprising instructions to extract a luminance signal and two color signals from a composite color television signal, comprising a chrominance signal being modulated on a sub-carrier which is located in the high-frequency part of the frequency spectrum of the luminance signal, the computer arrangement comprising processing means and a memory, the computer program product, after being loaded, providing said processing means with the capability to carry out:
acquiring a first sample of the composite color television signal, corresponding to a first pixel and other samples of the composite color television signal, corresponding to other pixels in a neighborhood of the first pixel;
estimating a first set of correlation values representing correlations between the first sample and the respective other samples, on basis of an initial separation of an approximation of the luminance signal from the composite color television signal;
estimating a second set of penalty values representing relations between the first sample and the respective other samples;
computing a third set of combined values by means of combining respective elements of the first set of correlation values and the second set of penalty values;
selecting a particular sample of the composite color television signal on basis of the corresponding combined value compared to further combined values of the third set of combined values; and
determining at least one final value of a set of values comprising a final luminance value and two color values corresponding to the first pixel on basis of the first sample and the particular sample.
